(19) United States
(12) Patent Application Publication
(10) Pub. No.: US 2007/0275271 A1
(43) Pub. Date: Nov. 29, 2007

(54) METHOD AND APPARATUS FOR CONTROLLING FUEL CELL IN PORTABLE DEVICE

(75) Inventor: Hyung Chul Lee, Hwaseong City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/748,877

(22) Filed: May 15, 2007

(30) Foreign Application Priority Data
May 16, 2006 (KR) 10-2006-0043930

(51) Int. Cl. H01M 8/04; H02J 7/00

(52) U.S. Cl. 429/9; 429/22; 307/65; 307/66

(57) ABSTRACT

The present invention relates to a method and apparatus for allowing a fuel cell to be used in a portable device. The apparatus according to the present invention includes a detecting unit for detecting which of a battery and a fuel cell is mounted in a battery mounting structure of the portable device. There is also provided a control unit for controlling charging and discharging modes of the battery or fuel cell depending on whether or not external power, i.e., commercial AC power is supplied to the portable device. The control unit causes the portable device to be normally operated and the power to be blocked from being supplied to the fuel cell not to charge it when the fuel cell is mounted in a state where the commercial AC power is supplied. On the other hand, when the battery is mounted, the control unit controls the portable device to be normally operated and the battery to be charged depending on the battery charging state. When the commercial AC power is not supplied and the fuel cell or the battery is mounted, the is control unit operates the portable device so that the power for operating the portable device is supplied from the fuel cell or the battery. Thus, according to the present invention, the fuel cell as well as the battery can be mounted to and used in the portable device.

### BACKGROUND

1. Field

The present invention relates to portable devices, and more particularly, to a method and apparatus for controlling a fuel cell in a portable device such as a notebook personal computer (PC) so that the fuel cell is not charged but is discharged when the fuel cell is mounted to the portable device.

2. Description of the Related Art

With the development of electronic communication technology, personal computers have come to be portable rapidly. For example, portable electronic devices, such as notebook PCs and personal digital assistants (PDAs), are designed with a small size or light weight in consideration of mobility, i.e., outdoor use.

A notebook PC is characterized in that it is driven by a battery, as well as by commercial AC power using an AC adaptor. This allows the notebook computer to be used at locations such as outdoor places and business trip places where commercial AC power is unavailable. A typical battery uses a rechargeable cell, such as a Li-Ion cell or a NiMH cell.

Meanwhile, a variety of power supply devices have been developed in order to further increase use time of a portable device, such as a notebook PC. A fuel cell, which generates and outputs electric power as fuel is supplied, is a representative example of the power supply device. In the fuel cell, fuel, e.g., hydrogen or methanol and air as an oxidizer gas are supplied to a stack so that the fuel and the air react to each other electrochemically and a charged body generates electric power.

The fuel cell has features of lower environmental pollution and higher efficiency in comparison with a battery. Accordingly, schemes of allowing the fuel cell to be used in portable electronic devices have been studied. For example, there has been developed a system in which both a battery and a fuel cell are used, and, in the system, power output from the battery or the fuel cell may be used for operation of the system under control of a central processing unit (CPU) of the system. In this scheme, however, since one system is equipped with both the fuel cell and the battery, a control unit is additionally needed, This complicates the system due to the additional mount of such a control unit.

Accordingly, there is a need for a scheme by which a battery or a fuel cell can be selectively mounted to a portable device. Since the fuel cell can be manufactured in the same shape as the battery, it can be mounted in a battery mount portion of the portable device.

At present, however, the portable device is designed so that the battery is charged when the AC adaptor is connected in a state where the battery is mounted in the battery mount portion. The battery and the fuel cell are charged in a different way. When the fuel cell is mounted in the battery mount portion in a state where the AC adaptor is connected, the fuel cell is supplied with external power from the AC adaptor to intend charging the fuel cell, which causes a risk. Accordingly, there is a need for a scheme of allowing the fuel cell to be only discharged when the fuel cell is mounted in the battery mount portion of the portable device.

### SUMMARY

Accordingly, an object of the present invention is to mount and use a fuel cell in a battery mount portion of a portable device.

Another object of the present invention is to selectively use a fuel cell or a battery that is mounted in a battery mount portion of a portable device.

Still another object of the present invention is not to perform charging operation of a fuel cell but to perform only discharging operation of the fuel cell when the fuel cell is mounted in a battery mount portion of a portable device.

According to an aspect of the present invention for achieving the objects, there is provided a method for controlling a fuel cell in a portable device, comprising the steps of: detecting which of a battery and a fuel cell is mounted to the portable device in a state where commercial AC power is converted into DC power with a predetermined voltage level and supplied to the portable device; and blocking the DC power from being supplied to the fuel cell if the fuel cell is mounted and charging the battery with the DC power if the battery is mounted.

The detecting step may be performed based on different logical signals according to which of the battery and the fuel cell is mounted.

Preferably, the logic signal with logic ‘high’ is output when one of the battery and fuel cell is mounted to the portable device, and the logic signal with logic ‘low’ is output when the other one is mounted.

Preferably, when one of switches on a path for supplying the DC power and a path for supplying operating power from the battery or the fuel cell is turned on, the other is turned off.

The method may further comprise the steps of determining whether the battery is fully charged, and charging the battery depending on the determination result.

According to another aspect of the present invention, there is provided a method for controlling a fuel cell in a portable device, comprising the steps of: determining whether commercial AC power is supplied from the outside; and if it is determined that the commercial AC power is blocked from being supplied, detecting the type of a currently mounted auxiliary power source and supplying operating power from the detected auxiliary power source, wherein any one of a battery and a fuel cell, as the auxiliary power source, is selectively mounted.

The method may further comprise the steps of: determining whether the commercial AC power is supplied while the operating power from the auxiliary power source is supplied; and if the commercial AC power is supplied, stopping supplying the operating power from the auxiliary power source and supplying DC power converted from the commercial AC power as the operating power.

Preferably, charging operation is performed using the DC power selectively depending on a charging state of the battery when the commercial AC power is supplied and the battery is mounted, and the DC power is blocked from being supplied to the fuel cell when the commercial AC power is supplied and the fuel cell is mounted.

According to a further aspect of the present invention, there is provided an apparatus for controlling a fuel cell in a portable device, comprising: a mount portion for mounting a battery or fuel cell with a predetermined voltage level; a detecting unit for detecting which of the battery and the fuel cell is mounted in the mount portion; and a control unit for blocking DC power, which is supplied as power for operating the portable device, from being supplied to the fuel cell when it is determined that the fuel cell is mounted based on an output signal of the detecting unit, the DC power.

The apparatus may further comprise a charging logic unit for supplying the DC power to the battery to charge the battery according to the control of the control unit.

Preferably, the output signal has logic ‘high’ when one of the battery and fuel cell is mounted to the mount portion, and the output signal has logic ‘low’ when the other one is mounted.

The apparatus may further comprise a first switch on a path for supplying the DC power, and a second switch on a path for supplying operating power from the battery or the fuel cell, wherein the control unit turns only the first switch on when the DC power is supplied and only the second switch on when the DC power is blocked from being supplied.

Preferably, when one of the first switch and the second switch is turned on, the other is turned off.

Preferably, when the DC power is blocked from being supplied, the operating power from the battery or fuel cell is supplied via the path established by the turned-on second switch.

According to a still further aspect of the present invention, there is provided an apparatus for controlling a fuel cell in a portable device, comprising: a power supply unit for converting commercial AC power into DC power and supplying it for operating the portable device; a battery or fuel cell selectively mounted to the portable device for supplying the operating power when the DC power is blocked from being supplied; and a control unit for blocking the DC power from being supplied to the fuel cell when the fuel cell is mounted to the portable device and the DC power is supplied.

The control unit may perform battery charging operation depending on a charging state of the battery when the battery is mounted to the portable device and the DC power is supplied.

The control unit may supply the operating power from a currently mounted battery or fuel cell when the DC power is blocked from being supplied.

Preferably, the control unit blocks a supply path of the battery or fuel cell so that only the DC power is supplied when the DC power is supplied after being blocked; and the control unit performs the battery charging operation when the battery is mounted and does not perform the charging operation when the fuel cell is mounted.

According to the present invention configured as above, using only a simple circuit, the charging operation of the fuel cell mounted in the battery mount portion of the portable device is not performed and the power of the fuel cell is used for operation of the portable device when the AC adaptor is not connected.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a block diagram illustrating a portable device for using a fuel cell according to a preferred embodiment of the present invention;

FIG. 2 is a flowchart illustrating a control process when a battery or fuel cell is mounted in a state where DC power is supplied during use of the portable device according to the preferred embodiment of the present invention; and

FIG. 3 is a flowchart illustrating a control process when a battery or feel cell is mounted in a state where DC power is not supplied during use of the portable device according to the preferred embodiment of the present invention.

### DETAILED DESCRIPTION

Hereinafter, a power control method and apparatus will be described with reference to the accompanying drawings.

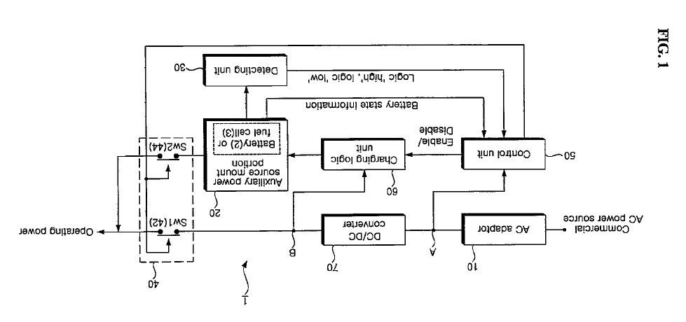

FIG. 1 is a block diagram illustrating a portable device for using a fuel cell according to a preferred embodiment of the present invention.

A portable device 1 shown in FIG. 1, such as a notebook personal computer (PC) comprises a battery 2 or a fuel cell 3, as a power source, in addition to commercial AC power source. The portable device 1 further comprises an auxiliary power source mount portion 20 for allowing the battery 2 or the fuel cell 3 to be mounted to the device. The auxiliary power source mount portion 20 is referred to as a battery mount portion that is generally disposed in the notebook PC.

The portable device 1 further comprises a detecting unit 30 for detecting which of the power source (i.e., battery or fuel cell) is mounted when any one of the battery 2 and the fuel cell 3 is mounted in the auxiliary power source mount portion 20. The detecting unit 30 comprises a plurality of pins, including a pin separately assigned to detect the fuel cell 3. Particularly, the detecting unit 30 includes a pin for detecting the battery 2 and a pin for detecting the fuel cell 3. Five pins are generally used for communication with the battery 2, wherein one of the pins is used for detecting the battery 2. In this embodiment, there is further provided the pin for detecting the fuel cell 3. Therefore, it is possible to determine whether or not there is the battery 2 or the fuel cell 3 and which of the power source is mounted in a case where the battery 2 is mounted and in a case where the fuel cell 3 is mounted. A signal for the determination is based on an output signal of the detecting unit 30. For example, a logic ‘high’ signal output from the battery detection pin indicates that the battery 2 is mounted, and a logic ‘low’ signal indicates that the fuel cell 3 is mounted, and vice versa. Alternatively, a pin for detection of the battery 2 and a pin for detection of the fuel cell 3 are provided, and it is determined that the battery 2 is mounted when the battery detection pin is in a logic ‘low’ state and the fuel-cell detection pin is in a logic ‘high’ state, and that the fuel cell 3 is mounted when the battery detection pin is in a logic ‘high’ state and the fuel-cell detection pin is in a logic ‘low’ state. On the contrary, it may be determined that the battery 2 is mounted when the battery detection pin is in a logic ‘high’ state and the fuel-cell detection pin is in a logic ‘low’ state, and that the fuel cell 3 is mounted when the battery detection pin is in a logic ‘low’ state and the fuel-cell detection pin is in a logic ‘high’ state. That is, it is possible on the basis of initial logic value settings to see which of the battery 2 and the fuel cell 3 is mounted.

The commercial AC power for the portable device 1 is converted into DC power by the AC adaptor 10 and supplied to respective loads of the portable device 1. The loads include a central processing unit (CPU), peripheral controller chips, a liquid crystal display (LCD)/backlight unit, a hard disk drive (HDD), an optical disk drive (ODD), a main memory and the like.

The portable device 1 further comprises a switching unit 40 for setting a path to supply the portable device 1 with the DC power converted by means of the AC adaptor 10 for operating the portable device 1, or to supply the portable device 1 with the power of the battery 2 or the fuel cell 3 for operating the portable device 1 when the AC adaptor 10 is not connected. In the switching unit 40, a first switch 42 is connected to an AC adaptor line, and a second switch 44 is connected to an output line of the auxiliary power source mount portion 20. When the AC adaptor 10 is connected, only the first switch 42 is on and the second switch 44 is off in order to supply the DC power as the operating power. On the other hand, when the AC adaptor 10 is not connected, the second switch 44 is on and the first switch 42 is off in order to supply the power of the battery 2 or the fuel cell 3 as the operating power.

It is preferred that the portable device 1 comprise a DC/DC converter 70 disposed at a previous stage of the switching unit 40 to drop the DC power converted by the AC adaptor 10 into power with a voltage level suitable for driving the loads and stabilizing the DC power.

The portable device 1 further comprises a control unit 50 for on/off controlling the first switch 42 and the second switch 44 selectively depending on whether the AC adaptor 10 is connected or not, and for outputting a charging enable signal or a charging disable signal to perform a battery charging mode or a fuel cell discharging mode after determining which of the battery 2 and the fuel cell 3 is mounted in the auxiliary power source mount portion 20 based on the output signal of the detecting unit 30.

The control unit 50 performs the battery charging mode when the AC adaptor 10 is connected to an external power input terminal A and the logic ‘high’ signal is output from the detecting unit 30 as the battery 2 is mounted in the auxiliary power source mount portion 20. That is, in the battery charging mode, because the AC adaptor 10 is connected, the power for operating the portable device 1 is supplied thereto through the first switch 42, and a portion of the DC power output from the DC/DC converter 70 is used to charge the battery 2 via a terminal B. The control unit 50 performs the fuel cell discharging mode when the AC adaptor 10 is connected to the external power input terminal A and a logic ‘low’ signal is output from the detecting unit 30 as the fuel cell 3 is mounted in the power source mount portion 20.

The portable device 1 further comprises a charging logic unit 60 for charging the battery 2 with the portion of the DC power supplied from the AC adaptor 10 in response to the charging enable signal from the control unit 50. The charging logic unit 60 does not charge the battery 2 upon receiving the charging disable signal.

In the battery charging mode, the control unit 50 reads battery state information, including total charging current, used capacity, remaining capacity and the like, from the battery 2 to recognize a charging state of the battery 2 and determines whether the battery 2 is to be charged. When it is determined that the battery 2 is fully charged, the control unit 50 sends the charging disable signal to the charging logic unit 60, causing the charging logic unit 60 to charge the battery no longer.

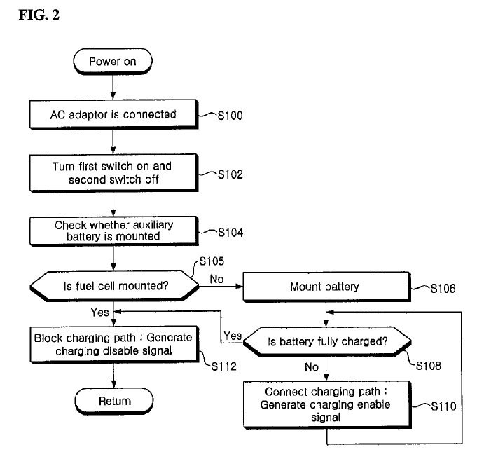

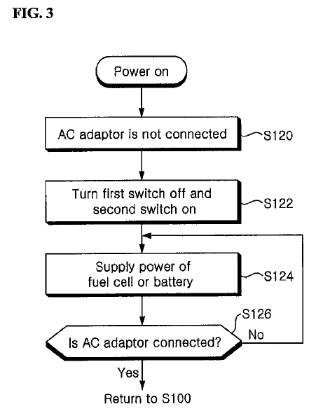

A method for controlling the fuel cell in the portable device according to the present invention so configured will now be described with reference to FIGS. 2 and 3, which illustrate the method separately according to a connection state of the AC adaptor.

When AC Adaptor Is Connected

FIG. 2 is a flowchart illustrating a control process when a battery or fuel cell is mounted in a state where DC power is supplied during use of the portable device according to the preferred embodiment of the present invention.

When the portable device 1 is powered on by a user, the control unit 50 checks in step S100 whether or not the AC adaptor 10 is connected to the external power input terminal A. When the voltage detected on the external power input terminal A is ‘high’, the control unit 50 determines that the AC adaptor 10 is connected. When it is determined that the AC adaptor 10 is connected, the control unit 50 turns the first switch 42 on and the second switch 44 off in step S102. Accordingly, the DC power input from the AC adaptor 10 is dropped and stabilized by the DC-DC converter 70 and then supplied as the operating power via the first switch 42.

In step S104, the control unit 50 checks whether or not the auxiliary battery is mounted in the auxiliary power source mount portion 20. The auxiliary battery check can be performed based on the logic signal output from the detecting unit 30. The control unit 50 then determines in step S105 which of the battery 2 and the fuel cell 3 is mounted. That is, the kind of the mounted power source is determined based on a logic level of the output signal of the detecting unit 30, which is ‘high’ when the battery 2 is mounted in the auxiliary power source mount portion 20 and ‘low’ when the fuel cell 3 is mounted. Of course, the power source currently mounted in the auxiliary power source mount portion 20 can also be determined based on logic signals output from a pin for detecting the battery 2 and a pin for detecting the fuel cell 3, if they are provided.

If it is determined in step S105 that the detecting unit 30 outputs a ‘high’ signal, the control unit 50 determines in step S106 that the battery 2 is mounted in the auxiliary power source mount portion 20. Then, the control unit 50 analyzes the battery state information read from the battery 2 and then determines in step S108 whether the battery 2 is filly charged. If it is determined that the battery 2 is not filly charged, the control unit 50 outputs the charging enable signal to the charging logic unit 60 in step S110. The charging logic unit 60 then provides a portion of the DC power supplied from the AC adaptor 10 as a charging power to the battery 2, thereby charging the battery 2.

However, if it is determined in step S108 that the battery is filly charged, the control unit 50 outputs the disable signal to the charging logic unit 60, causing the battery 2 not to be charged.

Meanwhile, when the detecting unit 30 outputs a ‘low’ signal, the control unit 50 determines that the fuel cell 3 is mounted in the auxiliary power source mount portion 20. When the fuel cell 3 is mounted, the DC power supplied from the AC adaptor 10 must not be supplied to the fuel cell 3.

In step S112, the control unit 50 outputs the charging disable signal to the charging logic unit 60. The charging logic unit 60 does not perform charging operation in response to the charging disable signal and blocks the DC power from being supplied to the fuel cell 3. Accordingly, the charging function of the fuel cell 3 is not performed.

In this manner, when the AC adaptor 10 is connected and the battery 2 is mounted, the control unit 50 of FIG. 1 supplies the DC power for operating the portable device 1 through the AC adaptor 10 and selectively performs battery charging operation depending on whether the battery 2 is fully charged. On the other hand, when the AC adaptor 10 is connected and the fuel cell 3 is mounted, the control unit 50 of FIG. 1 supplies only the DC power for operating the portable device 1 through the AC adaptor 10 and blocks the fuel cell 3 from being charged.

When AC Adaptor Is Not Connected

FIG. 3 is a flowchart illustrating a control process when a battery or fuel cell is mounted in a state where DC power is not supplied during use of the portable device according to the preferred embodiment of the present invention.

When a user wishes to use the portable device 1 at a place where commercial AC power is not available, the AC adaptor 10 is not connected to the external power input terminal A. Since it is detected that the DC power is not applied to the external power input terminal A, the signal on the external power input terminal A is in a logic ‘low’ state.

When the user operates a power switch (not shown) to power the device on, the control unit 50 detects an output level of the external power input terminal A to check whether or not the AC adaptor 10 is connected. When the output level is ‘low’, the control unit 50 determines in step S120 that the AC adaptor 10 is not connected.

The control unit 50 then turns the second switch 44 on in step S122 in order to supply the portable device I with the operating power from the battery 2 or the fuel cell 3 mounted in the auxiliary power source mount portion 20. When the second switch 44 is turned on, the first switch 42 is automatically turned off. If the second switch 44 is turned on, the control unit 50 controls to supply the operating power from the battery 2 or the fuel cell 3 mounted in the auxiliary power source mount portion 20 in step S124.

If the AC adaptor 10 is connected as in step S126 while the operating power from the battery 2 or the fuel cell 3 is supplied, the control unit 50 returns the process to step S100 in order for the operating power from the AC adaptor 10 to be supplied. That is, the control unit 50 turns the first switch 42 on and the second switch 44 off, The control unit 50 then performs the charging operation according to a charging state of the battery 2 when the battery 2 is mounted, and blocks the charging operation from being performed when the fuel cell 3 is mounted.

In this manner, according to the present invention, any one of the battery 2 and the fuel cell 3 can be mounted in the auxiliary power source mount portion 20 and used in the portable device 1. In a state where the DC power is being supplied through the AC adaptor 10, the battery is normally charged when the battery 2 is mounted, but the DC power is blocked from being supplied to the fuel cell 3 when the fuel cell 3 is mounted. The fuel cell 3 supplies the power for operating the portable device 1 only when the DC power is not supplied through the AC adaptor 10.

As described in detail above, according to the method and apparatus for controlling the fuel cell in the portable device of the present invention, the battery and the fuel cell can be selectively mounted to and used in the portable device, such as a notebook PC. Since the charging operation for the fuel cell is not performed but only the discharging operation is performed when the fuel cell is mounted, the fuel cell can be safely used in the portable device, with a simple circuit. Furthermore, the use time of the portable device can be extended because of the high efficiency of the fuel cell.

Although the present invention has been described in connection with the preferred embodiments, the embodiments of the present invention are only for illustrative purposes. It will be understood by those skilled in the art that various changes and modifications can be made thereto without departing from the technical spirit and scope of the present invention. Accordingly, the technical scope of the present invention will be defined by the technical spirit of the appended claims.

What is claimed is:

1. A method for controlling a fuel cell in a portable device, comprising the steps of:
detecting which of a battery and a fuel cell is mounted to the portable device in a state where commercial AC power is converted into DC power with a predetermined voltage level and supplied to the portable device; and
blocking the DC power from being supplied to the fuel cell if the fuel cell is mounted and charging the battery with the DC power if the battery is mounted.

2. The method as claimed in claim 1, wherein the detecting step is performed based on different logical signals according to which of the battery and the fuel cell is mounted.

3. The method as claimed in claim 2, wherein the logic signal with logic ‘high’ is output when one of the battery and fuel cell is mounted to the portable device, and the logic signal with logic ‘low’ is output when the other one is mounted.

4. The method as claimed in claim 1, wherein when one of switches on a path for supplying the DC power and a path for supplying operating power from the battery or the fuel cell is turned on, the other is turned off.

5. The method as claimed in claim 1, further comprising the steps of determining whether the battery is fully charged, and charging the battery depending on the determination result.

6. A method for controlling a fuel cell in a portable device, comprising the steps of:
determining whether commercial AC power is supplied from the outside; and
if it is determined that the commercial AC power is blocked from being supplied, detecting the type of a currently mounted auxiliary power source and supplying operating power from the detected auxiliary power source,
wherein any one of a battery and a fuel cell, as the auxiliary power source, is selectively mounted.

7. The method as claimed in claim 6, further comprising the steps of:
determining whether the commercial AC power is supplied while the operating power from the auxiliary power source is supplied; and
if the commercial AC power is supplied, stopping supplying the operating power from the auxiliary power source and supplying DC power converted from the commercial AC power as the operating power.

8. The method as claimed in claim 7, wherein charging operation is performed using the DC power selectively depending on a charging state of the battery when the commercial AC power is supplied and the battery is mounted, and the DC power is blocked from being supplied to the fuel cell when the commercial AC power is supplied and the fuel cell is mounted.

9. An apparatus for controlling a fuel cell in a portable device, comprising:
a mount portion for mounting a battery or fuel cell with a predetermined voltage level;
a detecting unit for detecting which of the battery and the fuel cell is mounted in the mount portion; and
a control unit for blocking DC power from being supplied to the fuel cell when it is determined that the fuel cell is mounted based on an output signal of the detecting unit, the DC power being supplied as power for operating the portable device.

10. The apparatus as claimed in claim 9, further comprising a charging logic unit for supplying the DC power to the battery to charge the battery according to the control of the control unit.

11. The apparatus as claimed in claim 9, wherein the output signal has a logic ‘high’ when one of the battery and fuel cell is mounted to the mount portion, and the output signal has a logic ‘low’ when the other one is mounted.

12. The apparatus as claimed in claim 9, further comprising a first switch on a path for supplying the DC power, and a second switch on a path for supplying operating power from the battery or the fuel cell, wherein the control unit turns only the first switch on when the DC power is supplied and only the second switch on when the DC power is blocked from being supplied.

13. The apparatus as claimed in claim 12, wherein when one of the first switch and the second switch is turned on, the other is turned off.

14. The apparatus as claimed in claim 12, wherein when the DC power is blocked from being supplied, the operating power from the battery or fuel cell is supplied via the path established by the turned-on second switch.

15. An apparatus for controlling a fuel cell in a portable device, comprising:
a power supply unit for converting commercial AC power into DC power and supplying it for operating the portable device;
a battery or fuel cell selectively mounted to the portable device for supplying the operating power when the DC power is blocked from being supplied; and
a control unit for blocking the DC power from being supplied to the fuel cell when the fuel cell is mounted to the portable device and the DC power is supplied.

16. The apparatus as claimed in claim 15, wherein the control unit performs battery charging operation depending on a charging state of the battery when the battery is mounted to the portable device and the DC power is supplied.

17. The apparatus as claimed in claim 16, wherein the control unit supplies the operating power from a currently mounted battery or fuel cell when the DC power is blocked from being supplied.

18. The apparatus as claimed in claim 17, wherein the control unit blocks a supply path of the battery or fuel cell so that only the DC power is supplied when the DC power is supplied after being blocked; and the control unit performs the battery charging operation when the battery is mounted and does not perform the charging operation when the fuel cell is mounted.
